(19) United States
(12) Patent Application Publication
(10) Pub. No.: US 2022/0397137 A1
(43) Pub. Date: Dec. 15, 2022

(54) FASTENING APPARATUS AND ELECTRICAL ROOM INCLUDING THE SAME

(71) Applicants: SK ecoplant Co., Ltd., Seoul (KR); BNDSOLUTION CO.,LTD., Gyeongju-si (KR)

(72) Inventors: Chang Sool Kim, Seoul (KR); Dae Hee Han, Seoul (KR); Jun Ho Min, Seoul (KR); Sang Chul Bae, Gyeongju-si (KR); Dae Sung Lim, Gyeongju-si (KR)

(21) Appl. No.: 17/806,301

(22) Filed: Jun. 10, 2022

(30) Foreign Application Priority Data
Jun. 10, 2021 (KR) 10-2021-0075632

(51) Int. Cl. F16B 2/06; H02B 1/42

(52) U.S. Cl. CPC F16B 2/06; H02B 1/42

(57) ABSTRACT

A fastening apparatus includes an inner casing including slots, an outer casing surrounding the inner casing, a shaft inserted into the inner casing, and fixed rolls between the outer casing and the shaft, wherein the fixed rolls are inserted into the slots, respectively, and a diameter of each of the fixed rolls is greater than a depth of each of the slots.

### CROSS-REFERENCE TO RELATED APPLICATION

This application is based on and claims priority under 35 U.S.C. § 119 to Korean Patent Application No. 10-2021-0075632, filed on Jun. 10, 2021, in the Korean Intellectual Property Office, the disclosure of which is incorporated by reference herein in its entirety.

### BACKGROUND

### 1. Field

One or more embodiments relate to a fastening apparatus and an electrical room including the same.

### 2. Description of the Related Art

Electrical devices (e.g., an electrical panel) arranged in an electrical room is fixed to the floor or wall of the electrical room for stability. A method of fixing an electrical device to an electrical room includes, for example, a method of using a jig clamp and a method of screw-coupling by using a fixed shaft and a bolt.

In the method of using a jig clamp, a fastening worker may be exposed to danger, and the jig clamp may be damaged. In the method of using a fixed shaft and a bolt, the bolt may be loosened due to vibration or the like.

### SUMMARY

One or more embodiments include a fastening apparatus for easy fastening operations, and an electrical room including the same.

One or more embodiments include a fastening apparatus that may allow a worker to safely perform a fastening operation, and an electrical room including the same.

However, problems to be solved are not limited to the above disclosure.

Additional aspects will be set forth in part in the description which follows and, in part, will be apparent from the description, or may be learned by practice of the presented embodiments of the disclosure.

According to one or more embodiments, a fastening apparatus includes an inner casing including slots, an outer casing surrounding the inner casing, a shaft inserted into the inner casing, and fixed rolls between the outer casing and the shaft, wherein the fixed rolls are inserted into the slots, respectively, and a diameter of each of the fixed rolls is greater than a depth of each of the slots.

The outer casing may include support protrusions protruding toward the fixed rolls.

Each of the support protrusions may have a width decreasing toward the inner casing.

The outer casing may be movable between a first position and a second position, in the first position, the support protrusions may be arranged to face the fixed rolls, respectively, and in the second position, the support protrusions may be arranged to be dislocated from the fixed rolls, respectively.

The fastening apparatus may further include a restoring spring between the inner casing and the outer casing, and the outer casing may include a cover portion covering the restoring spring, and a support portion covering the fixed rolls.

The fastening apparatus may further include a support nut on an opposite side of the support portion with respect to the restoring spring, and both end portions of the restoring spring may be in contact with the support nut and the support portion, respectively.

The fastening apparatus may further include an anti-loosening member passing through the support nut, and the anti-loosening member may be in contact with the inner casing.

The inner casing may include an outer flange extending in a direction from the inner casing toward the outer casing, and the outer casing may be in contact with the outer flange.

The inner casing may include locking protrusions protruding toward the slots, and a distance between the locking protrusions may be less than a diameter of each of the fixed rolls.

According to one or more embodiment, an electrical room includes a housing, an electrical panel in the housing, and a fastening apparatus between the housing and the electrical panel, wherein the fastening apparatus includes an inner casing including slots, an outer casing surrounding the inner casing, a shaft inserted into the inner casing, and fixed rolls between the outer casing and the shaft, wherein the fixed rolls are inserted into the slots, respectively, and a diameter of each of the fixed rolls is greater than a depth of each of the slots.

The outer casing may include support protrusions protruding toward the fixed rolls.

Each of the support protrusions may have a width decreasing toward the inner casing.

The inner casing may include locking protrusions protruding toward the slots, and a distance between the locking protrusions may be less than a diameter of each of the fixed rolls.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an exploded perspective view of a fastening apparatus according to an example embodiment;

FIG. 2 is a cross-sectional view of the fastening apparatus of FIG. 1;

FIG. 3 is an exploded view of the fastening apparatus of FIG. 2;

FIGS. 4 to 7 are cross-sectional views for explaining an operation in which a fastening casing and a shaft described with reference to FIGS. 1 to 3 are coupled;

FIGS. 8 and 9 are conceptual views of an electrical room for explaining an operation of fastening a housing and an electrical panel by using a fastening apparatus according to an example embodiment; and

FIGS. 10 and 11 are conceptual views of an electrical room for explaining an operation of fastening a housing and an electrical panel by using a fastening apparatus according to an example embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The present disclosure will now be described more fully with reference to the accompanying drawings, in which embodiments of the present disclosure are shown. Like reference numerals in the drawings denote like elements, and sizes of components in the drawings may be exaggerated for convenience of explanation. Meanwhile, embodiments described below are merely illustrative, and various modifications are possible from these embodiments.

Hereinafter, when a component is referred to as being “formed on” another component, it can be directly or indirectly formed on the other component.

An expression used in the singular may encompass the expression in the plural. In addition, when a portion “includes” an element, another element may be further included, rather than excluding the existence of the other element, unless otherwise described.

Also, terms such as “ . . . unit” described in the specification mean a unit that processes at least one function or operation.

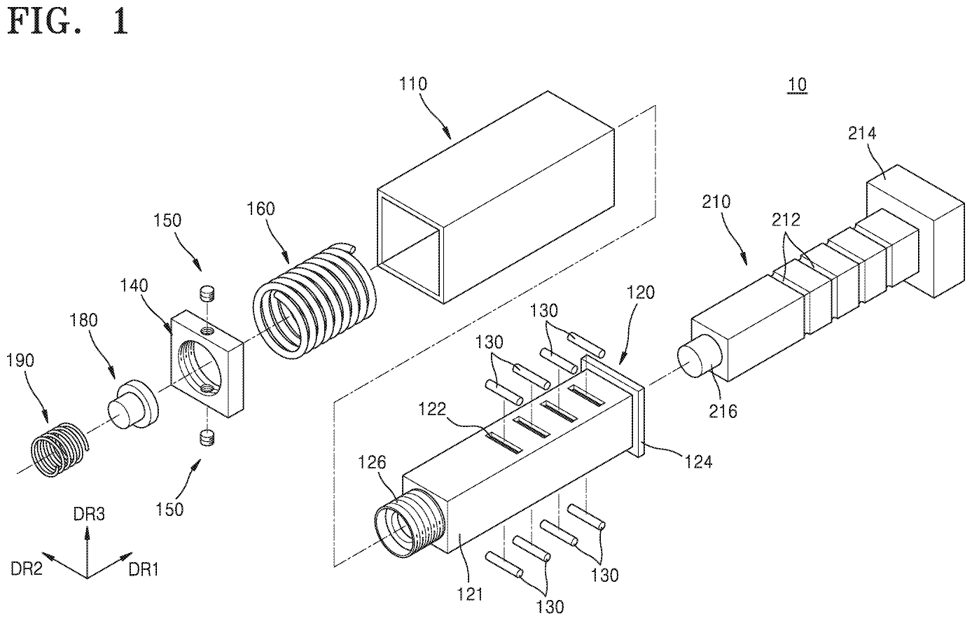

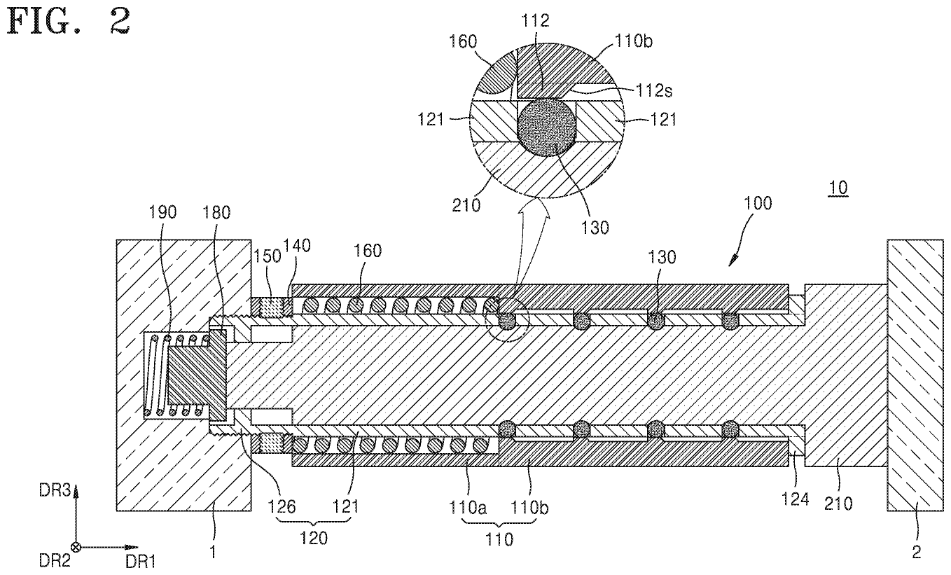

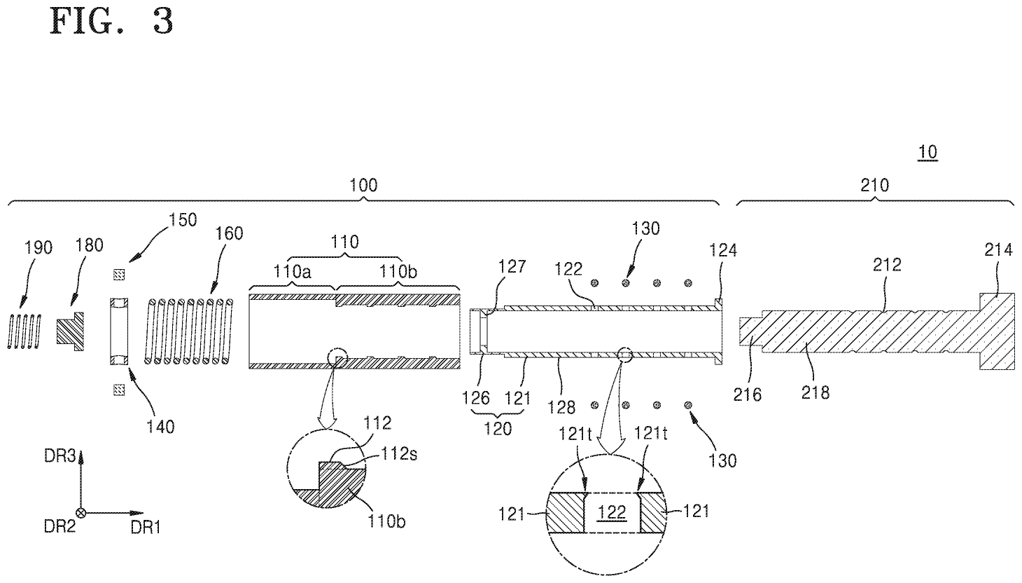

FIG. 1 is an exploded perspective view of a fastening apparatus according to an example embodiment. FIG. 2 is a cross-sectional view of the fastening apparatus of FIG. 1. FIG. 3 is an exploded view of the fastening apparatus of FIG. 2.

Referring to FIGS. 1 to 3, the fastening apparatus 10 may be provided. The fastening apparatus 10 may couple a first fastening object 1 and a second fastening object 2 to each other. The fastening apparatus 10 may include a fastening casing 100 and a shaft 210 coupled to the fastening casing 100. The shaft 210 may be inserted into the fastening casing 100. The fastening casing 100 may be coupled to the first fastening object 1, and the shaft 210 may be coupled to the second fastening object 2.

The fastening casing 100 may include an inner casing 120, fixed rolls 130, an outer casing 110, a support nut 140, anti-loosening members 150, a restoring spring 160, a buffer pin 180, and a buffer spring 190. The inner casing 120 may have a tubular shape extending in a first direction DR1.

The inner casing 120 may include a coupling portion 126 and a body portion 121, which are arranged in the first direction DR1. The coupling portion 126 may be fixed to the first fastening object 1. The coupling portion 126 may have a circular tube-shape, and may have a screw thread on the outer surface thereof. The coupling portion 126 may be screw-coupled to the first fastening object 1. However, the coupling portion 126 is not limited to being screw-coupled to the first fastening object 1. As another example, the coupling portion 126 may be coupled to the first fastening object 1 by using welding.

An outer surface of the body portion 121 may be formed to have a polygonal column shape. For example, the body portion 121 may have a quadrangular column shape. An area defined by an inner surface of the outer casing 110 into which the body portion 121 is inserted may have a polygonal column shape corresponding to the body portion 121. The body portion 121 may be fixed to the outer casing 110 without rotating with respect to the outer casing 110.

The body portion 121 may include an outer flange 124. For example, the outer flange 124 may be provided at an end portion of the body portion 121, the end portion being opposite to the coupling portion 126. The outer flange 124 may protrude from an outer surface of the body portion 121, the outer surface being adjacent to the outer flange 124.

Slots 122 may be provided in the body portion 121. The slots 122 may be arranged in the first direction DR1. The slots 122 may each pass through the body portion 121. The slots 122 may each extend in a second direction DR2 intersecting with the first direction DR1. The first direction DR1 and the second direction DR2 may be orthogonal to each other. The slots 122 may be provided on sidewalls of the body portion 121, the sidewalls facing each other. Although the slots 122 are shown to be provided on sidewalls of the body portion 121, the sidewalls facing each other in a third direction DR3 intersecting with the second direction DR2, the present disclosure is not limited thereto. In another example, the slots 122 may be provided on sidewalls of the body portion 121, the sidewalls facing each other in the second direction DR2, or may be provided on all sidewalls of the body portion 121. The first, second, and third directions DR1, DR2, and DR3 may be orthogonal to one another. Although it is illustrated that four slots 122 are provided on one sidewall of the body portion 121, this is an example. In another example, less than or more than four slots 122 may be provided on one sidewall of the body portion 121.

The fixed rolls 130 may be inserted into the slots 122. Although it is shown that one fixed roll 130 is provided in one slot 122, this is an example. In another example, equal to or more than two fixed rolls 130 may be inserted into one slot 122. The fixed rolls 130 may each have a circular column shape extending in the second direction DR2. However, the shape of each of the fixed rolls 130 is not limited to a circular column shape. In another example, the fixed rolls 130 may each have a polygonal column shape.

The body portion 121 may include locking protrusions 121t protruding toward the slots 122. The locking protrusions 121t may prevent the fixed rolls 130 from completely passing through the slots 122. The locking protrusions 121t may each have a shape that increases toward an inner side of the inner casing 120. However, the shape of each of the locking protrusions 121t is not limited and may be determined as necessary. A distance between the locking protrusions 121t facing each other may be less than a diameter of the each of the fixed rolls 130.

A width of each of the slots 122 in a portion where the locking protrusions 121t are not provided may be equal to or greater than a diameter of each of the fixed rolls 130. For example, the width of each of the slots 122 may be the size of each of the slots 122 in the first direction DR1. A width of each of the slots 122 in a portion where the locking protrusions 121t are provided may be less than the diameter of each of the fixed rolls 130. A depth of each of the slots 122 may be less than the diameter of each of the fixed rolls 130. For example, the depth of each of the slots 122 may be the size of each of the slots 122 in the second direction DR2. The depth of each of the slots 122 may be substantially equal to a thickness of a sidewall of the body portion 121.

The inner casing 120 may include an inner flange 127. The inner flange 127 may protrude from an inner side surface of the inner casing 120. The inner flange 127 may divide an inner area of the inner casing 120 into an area in which the buffer pin 180 is provided and an area in which the shaft 210 is provided. For example, the area in which the shaft 210 is provided may be apart from the area in which the buffer pin 180 is provided in the first direction DR1 with the inner flange 127 therebetween. For example, the inner flange 127 is shown to be provided in the coupling portion 126, but this is an example. In another example, the inner flange 127 may be provided in the body portion 121.

The support nut 140 may be provided on the coupling portion 126 of the inner casing 120. A screw thread may be provided on an inner surface of the support nut 140. Accordingly, the support nut 140 and the coupling portion 126 may be screw-coupled to each other. The support nut 140 may have a quadrangular column shape. However, the shape of the support nut 140 is not limited. In another example, the support nut 140 may have a circular column shape or a polygonal column shape other than a quadrangular shape.

The anti-loosening members 150 may be inserted into the support nut 140. The anti-loosening members 150 may each extend from an outer surface to an inner surface of the support nut 140 to pass through the support nut 140. The anti-loosening members 150 may be in contact with the coupling portion 126 of the inner casing 120. In an example, grooves (not shown) into which end portions of the anti-loosening members 150 are inserted may be formed on a surface of the coupling portion 126 in contact with the anti-loosening members 150. Each of the anti-loosening members 150 and the support nut 140 may be screw-coupled to each other. Two anti-loosening members 150 are shown, but this is an example. In another example, one anti-loosening member 150 or at least three anti-loosening members 150 may be provided.

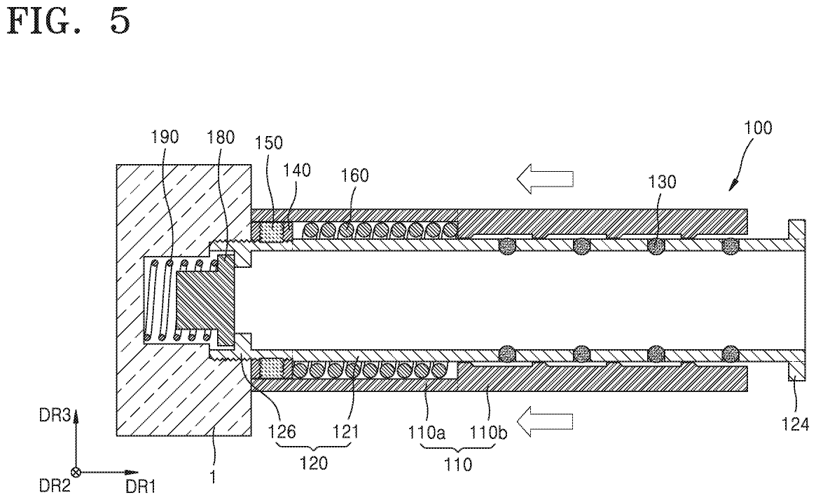

The outer casing 110 may surround the inner casing 120. The outer casing 110 may have a tubular shape extending in the first direction DR1. The outer casing 110 may include a cover portion 110a and a support portion 110b, which are arranged in the first direction DR1. The outer casing 110 may move with respect to the inner casing 120 in the first direction DR1. For example, the outer casing 110 may be arranged at a first position (a position of the outer casing 110 shown in FIG. 2) that arranges the fixed rolls 130 close to an inner area of the inner casing 120 or a second position (a position of the outer casing 110 shown in FIG. 5) that allows the fixed rolls 130 to move in a direction away from the inner area of the inner casing 120.

The cover portion 110a may define an area that accommodates the restoring spring 160 between the inner casing 120 and the cover portion 110a. A thickness of a sidewall of the cover portion 110a may be less than a thickness of a sidewall of the support portion 110b. An inner surface of the cover portion 110a and an inner surface of the support portion 110b may have a step difference, the inner surfaces facing the inner casing 120. A connection surface between the inner surface of the cover portion 110a and the inner surface of the support portion 110b may be in contact with an end of the restoring spring 160. In an example, when the outer casing 110 is arranged at the first position, the cover portion 110a may not cover the support nut 140, and when the outer casing 110 is arranged at the second position, the cover portion 110a may cover the support nut 140. As another example, when the outer casing 110 is arranged at the first position, the cover portion 110a may slightly cover the support nut 140 than a case where the outer casing 110 is arranged at the second position.

The support portion 110b may include support protrusions 112. The support protrusions 112 may protrude toward the inner casing 120. The support protrusions 112 may extend in the second direction DR2. The support protrusions 112 may extend in the first direction DR1. When the outer casing 110 is arranged at the first position, the support protrusions 112 may be aligned to respectively face the fixed rolls 130, so that the fixed rolls 130 may be arranged close to the inner area of the inner casing 120. For example, the support protrusions 112 may directly contact the fixed rolls 130. When the outer casing 110 is positioned at the second position, the support protrusions 112 may be arranged to be dislocated from the fixed rolls 130, so that the fixed rolls 130 may move in a direction away from the inner area of the inner casing 120. For example, the fixed rolls 130 may move to a position around the support protrusions 112, the position being in contact with the inner surface of the support portion 110b. The support protrusions 112 may each have a width that increases in a direction away from the inner casing 120. For example, the width of each of the support protrusions 112 may be the size of each of the support protrusions 112 in the first direction DR1. The support protrusions 112 may include inclined side surfaces 112s. The inclined side surfaces 112s may be configured such that the support protrusions 112 may push the fixed rolls 130 when the outer casing 110 moves from the second position to the first position. For example, the inclined side surfaces 112s may be side surfaces of the support protrusions 112, the side surfaces facing the first direction DR1. The support portion 110b may be in contact with the outer flange 124 of the inner casing 120 at the first position.

The restoring spring 160 may be provided between the cover portion 110a and the inner casing 120 and between the support nut 140 and the support portion 110b. Both end portions of the restoring spring 160 may be in contact with the support nut 140 and the support portion 110b, respectively. When the outer casing 110 moves from the first position to the second position, the outer casing 110 may compress the restoring spring 160. The restoring spring 160 may push the outer casing 110 in a direction in which the outer casing 110 returns to the first position.

The buffer pin 180 and the buffer spring 190 may be provided in an area divided by the inner flange 127. The buffer pin 180 and the buffer spring 190 may alleviate the shock of the shaft 210 when the shaft 210 is inserted. The buffer spring 190 may be provided between the first fastening object 1 and the inner flange 127. The buffer pin 180 may be provided between the buffer spring 190 and the inner flange 127. The buffer pin 180 may include a portion inserted into the buffer spring 190 and a flange portion that pushes the buffer spring 190. A width of the flange portion of the buffer pin 180 may be less than a distance between inner flanges 127. For example, the width of the flange portion of the buffer pin 180 may be the size of the buffer pin 180 in the second direction DR2.

The shaft 210 may be inserted into the inner casing 120. The shaft 210 may include a shaft body portion 218, a shaft protruding portion 216, and a shaft flange 214. The shaft body portion 218 may extend in the first direction DR1. The shaft body portion 218 may have a polygonal column shape corresponding to the shape formed by the inner surface of the inner casing 120. For example, the shaft body portion 218 may have a quadrangular column shape. Accordingly, the shaft 210 may not rotate with respect to the inner casing 120.

The shaft body portion 218 may include fixed grooves 212. The fixed grooves 212 may accommodate the fixed rolls 130. The fixed grooves 212 on surfaces of the shaft body portion 218 that intersects with the third direction DR3 may extend in the second direction DR2, and the slots 122 on surfaces of the body portion 121 that intersects with the second direction DR2 may extend in the third direction DR3.

The shaft flange 214 may be provided at an end portion of the shaft body portion 218. The shaft flange 214 may protrude from a side surface of the shaft body portion 218. The shaft flange 214 may be in contact with the outer flange 124. The shaft flange 214 and the shaft body portion 218 may be in contact with the second fastening object 2. For example, the shaft flange 214 and the shaft body portion 218 may be welded to the second fastening object 2.

The shaft protruding portion 216 may be provided on an opposite side to the shaft flange 214 with respect to the shaft body portion 218. The shaft protruding portion 216 may have a circular column shape extending in the first direction DR1. The shaft protruding portion 216 may be inserted between the inner flanges 127 and come into contact with the buffer pin 180. The shaft protruding portion 216 may push the buffer pin 180 in a direction away from the inner flange 127. The buffer pin 180 may be moved by the shaft protruding portion 216. For example, the buffer pin 180 may move until coming into contact with the first fastening object 1. When the buffer pin 180 is moved, the buffer pin 180 may compress the buffer spring 190.

Hereinafter, an operation in which the fastening casing 100 and the shaft 210 are coupled is described.

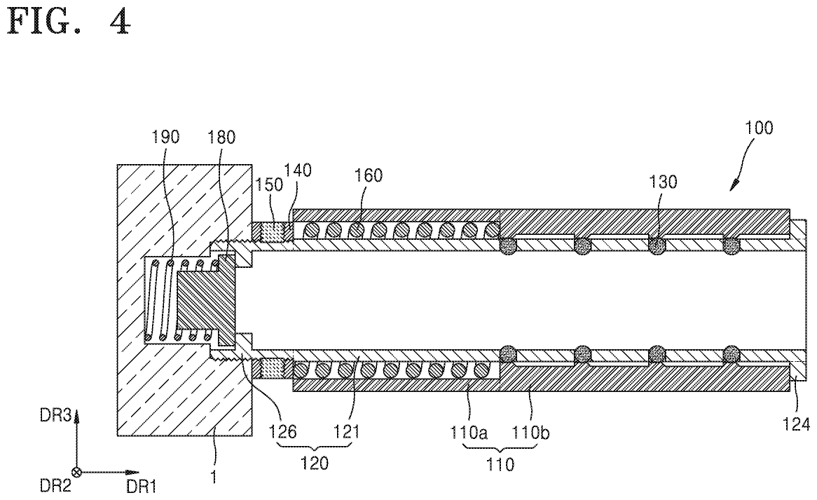

FIGS. 4 to 7 are cross sectional views for explaining an operation in which the fastening casing 100 and the shaft 210 described with reference to FIGS. 1 to 3 are coupled.

Referring to FIG. 4, the fastening casing 100 may be coupled to the first fastening object 1. For example, the fastening casing 100 and the fastening casing 100 may be screw-coupled to each other. The first fastening object 1 may include a groove in which a screw thread is formed, the screw thread corresponding to the screw thread of the coupling portion 126. The first fastening object 1 may further include a groove into which the buffer spring 190 and the buffer pin 180 are inserted. From a viewpoint in the first direction DR1, the groove into which the buffer spring 190 and the buffer pin 180 are inserted may overlap the groove in which the screw thread is formed.

The buffer spring 190 may push the buffer pin 180 toward the inner flange 127. Because the width of a flange portion of the buffer pin 180 is greater than a distance between the inner flanges 127, the flange portion of the buffer pin 180 may be in contact with the inner flanges 127.

The restoring spring 160 may push the outer casing 110 in the first direction DR1. For example, the outer casing 110 may be arranged at the first position which is in contact with the outer flange 124.

The support protrusions 112 may adjust the positions of the fixed rolls 130 so that the fixed rolls 130 are arranged close to the inner area of the inner casing 120. For example, the fixed rolls 130 may be fixed between the support protrusions 112 and the locking protrusions 121t. When the fixed rolls 130 are arranged close to the inner area of the inner casing 120, a portion of each of the fixed rolls 130 may protrude from the inner surface of the inner casing 120.

Referring to FIG. 5, the outer casing 110 may move toward the first fastening object 1. For example, a fastening worker may move the outer casing 110 toward the first fastening object 1. For example, the outer casing 110 may be arranged at the second position which is in contact with the first fastening object 1. The cover portion 110a of the outer casing 110 may cover the support nut 140 and the anti-loosening members 150. The restoring spring 160 may be compressed by the support portion 110b. The support protrusions 112 may be arranged to be dislocated from the fixed rolls 130 so that the fixed rolls 130 may move toward the outer casing 110.

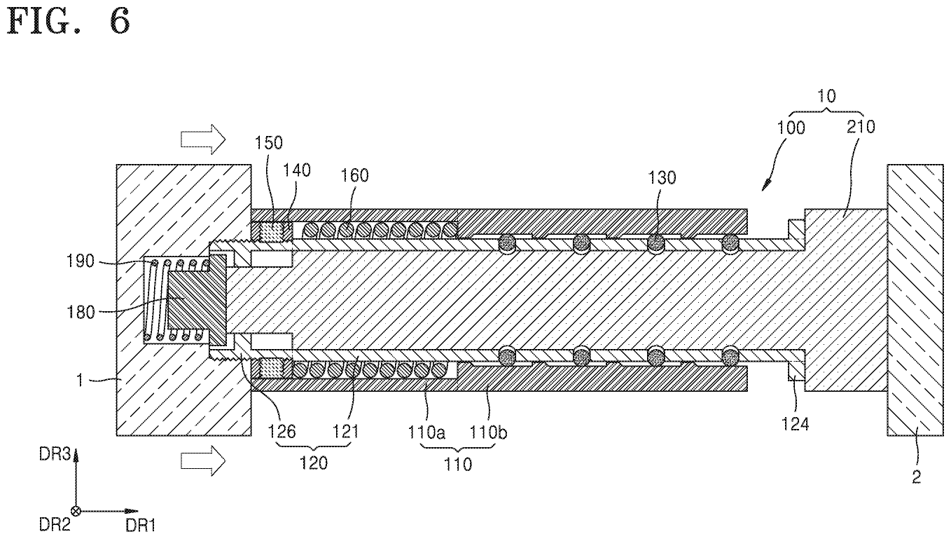

Referring to FIG. 6, the shaft 210 may be inserted into the fastening casing 100. The outer casing 110 may be positioned at the second position. For example, when the shaft 210 is inserted into the fastening casing 100, a fastening worker may apply a force to the outer casing 110 so that the outer casing 110 is arranged at the second position. When the shaft 210 is inserted into the inner casing 120, the shaft 210 may push the fixed rolls 130 toward the outer casing 110. The fixed rolls 130 may move toward the outer casing 110. For example, the fixed rolls 130 may move until coming into contact with the inner surface of the support portion 110b around the support protrusions 112. The shaft flange 214 may be in contact with the outer flange 124.

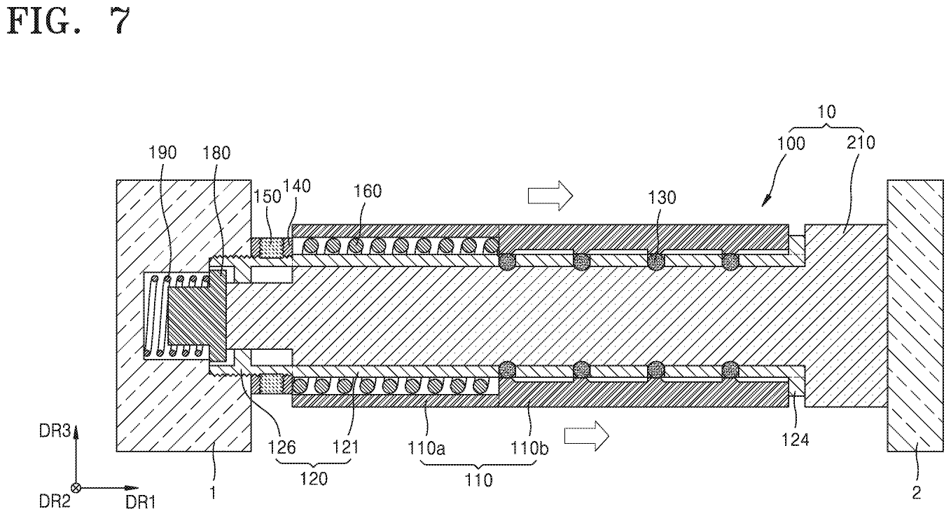

Referring to FIG. 7, the outer casing 110 may be moved toward the second fastening object 2 by the restoring spring 160. For example, a fastening worker may not apply a force to the outer casing 110. The outer casing 110 may be moved until coming into contact with the outer flange 124. In other words, the outer casing 110 may be moved to the first position by the restoring spring 160.

The support protrusions 112 may push the fixed rolls 130 toward the shaft 210. Because the support protrusions 112 have the inclined side surfaces 112s, the support protrusions 112 may easily push the fixed rolls 130. The support protrusions 112 may be inserted into fixed grooves 212 of the shaft 210. The support protrusions 112 may support the fixed rolls 130 so that the fixed rolls 130 are not discharged from the fixed grooves 212. The fixed rolls 130 should be discharged from the fixed grooves 212 to separate the shaft 210 from the fastening casing 100. The support protrusions 112 in the present disclosure may be configured such that the shaft 210 is not separated from the fastening casing 100.

The fastening casing 100 and the shaft 210 of the present disclosure may be coupled to each other by removing a force applied to the outer casing 110 after the shaft 210 is inserted into the fastening casing 100 in a state in which the outer casing 110 is moved toward the first fastening object 1. Accordingly, a fastening operation may be easy, and safety for a fastening worker may be improved.

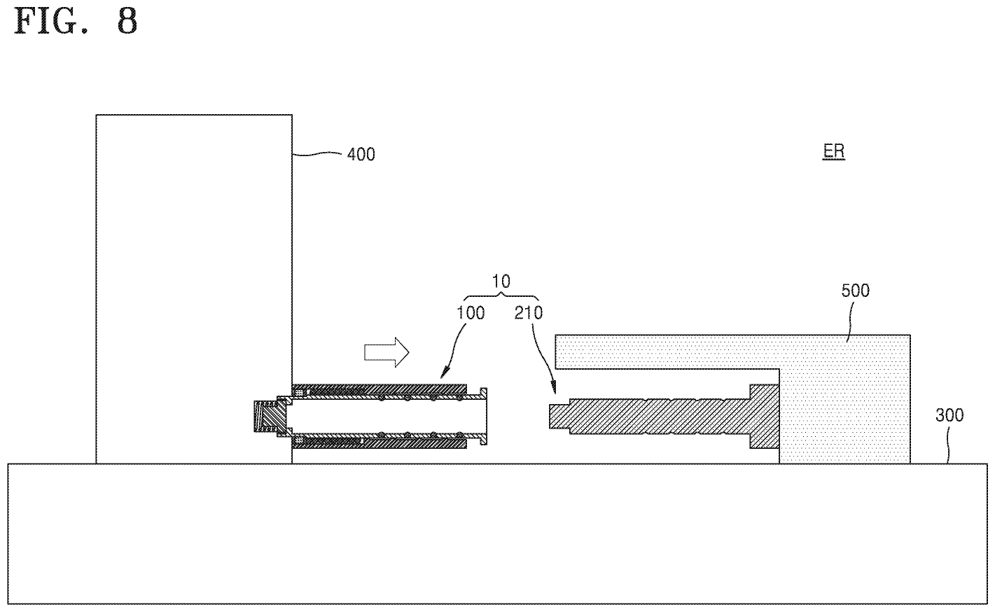

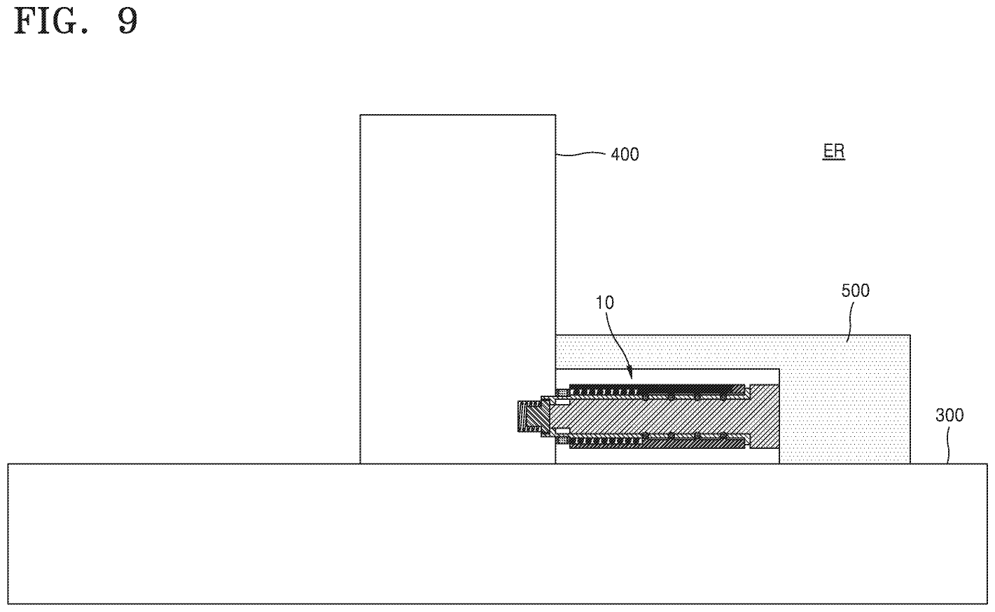

FIGS. 8 and 9 are conceptual views of an electrical room ER for explaining an operation of fastening a housing and an electrical panel by using a fastening apparatus according to an example embodiment. For brevity of description, descriptions already given with reference to FIGS. 4 to 7 may be omitted.

Referring to FIG. 8, the electrical room ER may be provided. The electrical room ER may include a housing 300, an electrical panel 400, a connector 500, the fastening casing 100, and the shaft 210. For brevity of description, sidewalls and a ceiling portion of the housing 300 are not shown, except for a bottom portion thereof. Each component is shown exaggerated or reduced.

The electrical panel 400 may be provided on the bottom portion of the housing 300. The electrical panel 400 may not be fixed on the bottom portion of the housing 300. The fastening casing 100 may be coupled to a sidewall of the electrical panel 400. For example, the fastening casing 100 may be screw-coupled to the sidewall of the electrical panel 400. The fastening casing 100 may extend in a direction parallel to an upper surface of the bottom portion of the housing 300.

The connector 500 may be provided on the bottom portion of the housing 300. The connector 500 may be fixed to the bottom portion of the housing 300. A shape or material of the connector 500 may be defined as necessary.

The shaft 210 may be fixed to the connector 500. For example, the shaft 210 may be welded to the connector 500. The shaft 210 may extend in a direction parallel to the upper surface of the bottom portion of the housing 300. The shaft 210 may be arranged to face the fastening casing 100.

Referring to FIG. 9, the electrical panel 400 may be moved so that the shaft 210 is inserted into the fastening casing 100. The shaft 210 may be fully inserted into the fastening casing 100, so that the outer flange 124 may be in contact with the shaft flange 214. A force pulling the outer casing 110 toward the electrical panel 400 may be removed, and the outer casing 110 may be moved toward the connector 500. Accordingly, the fastening casing 100 may be coupled to the shaft 210.

One fastening apparatus 10 is shown, but it is an example. In another example, at least two fastening apparatuses 10 may be provided.

The present disclosure may provide an electrical room ER including the electrical panel 400 and the housing 300, which are coupled by using the connector 500 and the fastening apparatus 10.

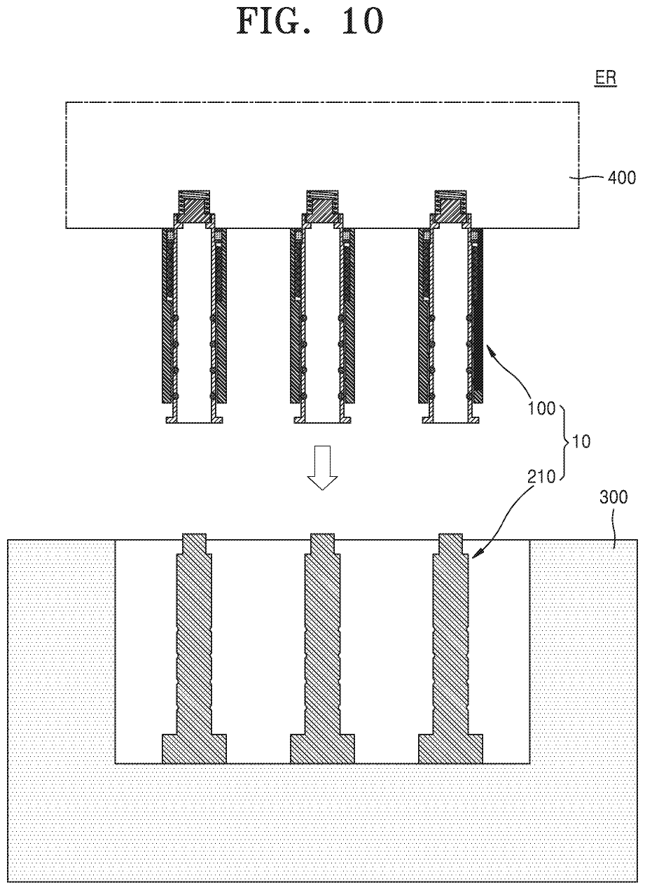

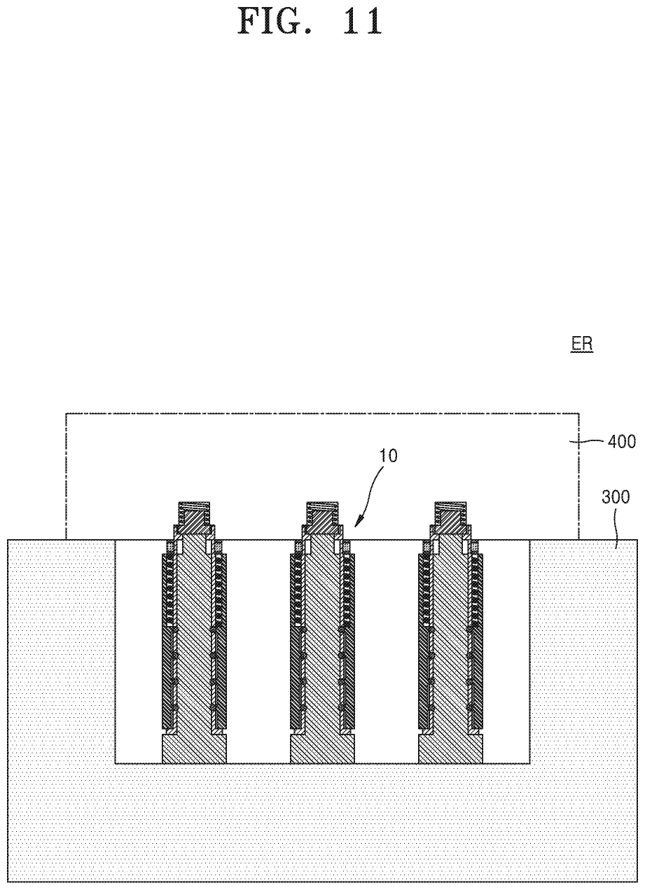

FIGS. 10 and 11 are conceptual views of the electrical room ER for explaining an operation of fastening the housing 300 and the electrical panel 400 by using the fastening apparatus 10 according to an example embodiment. For brevity of description, descriptions already given with reference to FIGS. 4 to 7 may be omitted.

Referring to FIG. 10, the electrical room ER may be provided. The electrical room ER may include the housing 300, the electrical panel 400, fastening casings 100, and shafts 210. For brevity of description, sidewalls and a ceiling portion of the housing 300 are not shown, except for the bottom portion of the housing 300. Each component is shown exaggerated or reduced.

The electrical panel 400 may be provided to be apart from the bottom portion of the housing 300. Unlike to that shown in FIG. 8, the fastening casings 100 may be coupled to a lower portion of the electrical panel 400. For example, the fastening casings 100 may be screw-coupled to the lower portion of the electrical panel 400. The fastening casings 100 may extend in a direction perpendicular to an upper surface of the bottom portion of the housing 300.

A groove for accommodating the shafts 210 may be provided at the bottom portion of the housing 300. The shafts 210 may be provided in the groove to be fixed to the bottom portion of the housing 300. For example, the shafts 210 may be welded to the bottom portion of the housing 300. The shafts 210 may extend in a direction perpendicular to the upper surface of the bottom portion of the housing 300. The shafts 210 may respectively face the fastening casings 100.

Referring to FIG. 11, the electrical panel 400 may be moved so that the shafts 210 are respectively inserted into the fastening casings 100. For example, the electrical panel 400 may move toward the housing 300 in a direction parallel to the upper surface of the bottom portion of the housing 300. The shafts 210 may be completely inserted into the fastening casings 100, so that a force pulling the fastening casings 110 toward the electrical panel 400 may be removed after the outer flanges 124 come into contact with the shaft flange 214. The outer casings 110 may move toward the bottom portion of the housing 300, so that the fastening casings 100 may be coupled to the shafts 210, respectively.

Three fastening apparatuses 10 are shown, but it is an example. In another embodiment, less than three or more than three fastening apparatuses 10 may be provided.

The present disclosure may provide an electrical room ER including the electrical panel 400 and the housing 300, which are coupled by using the connector 500 and the fastening apparatus 10.

The present disclosure may provide a fastening apparatus for easy fastening operations, and an electrical room including the same.

The present disclosure may include a fastening apparatus in which safety for workers performing fastening operations is improved, and an electrical room including the same.

However, effects of the present disclosure is not limited to the above disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A fastening apparatus comprising:
an inner casing comprising slots;
an inner flange protruding from an inner surface of the inner casing;
an outer casing surrounding the inner casing;
a shaft inserted into the inner casing and facing the inner flange;
fixed rolls between the outer casing and the shaft;
a buffer spring on an opposite side of the shaft with respect to the inner flange; and
a buffer pin between the buffer spring and the inner flange;
wherein the shaft comprises a shaft body portion and a shaft protruding portion protruding from the shaft body portion,
the shaft protruding portion is inserted between inner flanges and configured to push the buffer pin in a direction away from the inner flanges,
the shaft body portion comprises fixed grooves configured to surround a side surface of the shaft body portion to accommodate the fixed rolls,
the fixed rolls are inserted into the slots, respectively, and
a diameter of each of the fixed rolls is greater than a depth of each of the slots.

2. The fastening apparatus of claim 1, wherein the outer casing comprises support protrusions protruding toward the fixed rolls.

3. The fastening apparatus of claim 2, wherein each of the support protrusions has a width decreasing toward the inner casing.

4. The fastening apparatus of claim 2, wherein the outer casing is movable between a first position and a second position,
in the first position, the support protrusions are arranged to face the fixed rolls, respectively,
in the second position, the support protrusions are arranged to be dislocated from the fixed rolls, respectively.

5. The fastening apparatus of claim 1, further comprising a restoring spring between the inner casing and the outer casing,
wherein the outer casing comprises a cover portion covering the restoring spring, and a support portion covering the fixed rolls.

6. The fastening apparatus of claim 5, further comprising a support nut on an opposite side of the support portion with respect to the restoring spring,
wherein both end portions of the restoring spring are in contact with the support nut and the support portion, respectively.

7. The fastening apparatus of claim 6, further comprising an anti-loosening member passing through the support nut,
the anti-loosening member is in contact with the inner casing.

8. The fastening apparatus of claim 1, wherein the inner casing comprises an outer flange extending in a direction from the inner casing toward the outer casing,
the outer casing is in contact with the outer flange.

9. The fastening apparatus of claim 1, wherein the inner casing comprises locking protrusions protruding toward the slots, and
a distance between the locking protrusions is less than a diameter of each of the fixed rolls.

10. An electrical room comprising:
a housing;
an electrical panel in the housing; and
a fastening apparatus between the housing and the electrical panel,
wherein the fastening apparatus comprises:
an inner casing comprising slots;
an inner flange protruding from an inner surface of the inner casing;
an outer casing surrounding the inner casing;
a shaft inserted into the inner casing and facing the inner flange;
fixed rolls between the outer casing and the shaft;
a buffer spring on an opposite side of the shaft with respect to the inner flange; and
a buffer pin between the buffer spring and the inner flange;
wherein the fixed rolls are inserted into the slots, respectively,
the shaft comprises a shaft body portion and a shaft protruding portion protruding from the shaft body portion,
the shaft protruding portion is inserted between inner flanges and configured to push the buffer pin in a direction away from the inner flanges,
the shaft body portion comprises fixed grooves configured to surround a side surface of the shaft body portion to accommodate the fixed rolls, and
a diameter of each of the fixed rolls is greater than a depth of each of the slots.

11. The electrical room of claim 10, wherein the outer casing comprises support protrusions protruding toward the fixed rolls.

12. The electrical room of claim 11, wherein each of the support protrusions has a width decreasing toward the inner casing.

13. The electrical room of claim 10, wherein the inner casing comprises locking protrusions protruding toward the slots, and
a distance between the locking protrusions is less than a diameter of each of the fixed rolls.
